(19) United States
(12) Patent Application Publication
(10) Pub. No.: US 2005/0238102 A1
(43) Pub. Date: Oct. 27, 2005

(54) Hierarchical motion estimation apparatus and method

(75) Inventors: Jae-hun Lee, Yongin-si (KR); Chan-sik Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/111,768

(22) Filed: Apr. 22, 2005

Related U.S. Application Data
(60) Provisional application No. 60/564,610, filed on Apr. 23, 2004.

(30) Foreign Application Priority Data
May 11, 2004 (KR) 2004-0033118

(51) Int. Cl. H04N 7/12

(52) U.S. Cl. 375/240.16; 348/699; 375/240.12; 375/240.24

(57) ABSTRACT

A motion estimation apparatus and method for efficient hierarchical motion estimation. The motion estimation apparatus includes a pixel data storing unit storing pixel data of a block to search for and pixel data of blocks in a search area a two-dimensional processing element array receiving pixel data from the pixel data storing unit and calculating degrees of similarity between the block to search for and the blocks in the search area, a merging and comparing unit merging the degrees of similarity, generating degrees of similarity for blocks of various sizes, comparing the generated degrees of similarity, and outputting motion vectors for the blocks of various sizes, and an address controlling unit controlling an address of the pixel data storing unit such that the pixel data of the pixel data storing unit can be sequentially transmitted to the two-dimensional processing element array.

### CROSS-REFERENCE TO RELATED APPLICATIONS

This application claims the benefit of Korean Patent Application No. 2004-0033118, filed on May 11, 2004, in the Korean Intellectual Property Office, and the benefit of U.S. Provisional Patent Application No. 60/564,610, filed on Apr. 23, 2004, in the U.S. Patent and Trademark Office, the disclosures of which are incorporated herein by reference.

### BACKGROUND OF THE INVENTION

1. Field of the Invention

The present invention relates to motion estimation, and more particularly, to a motion estimation apparatus and method for efficient hierarchical motion estimation.

2. Description of Related Art

Motion estimation is a process of searching a previous frame for a macro-block most similar to a macro-block in a current frame using a specified measurement function and obtaining a motion vector, which indicates the difference between the position of the macro-block in the previous frame and that of the macro-block in the current frame.

There are many ways to find the most similar macro-block. For example, while moving macro-blocks included in a specified search area of a previous frame in units of pixels, degrees of similarity between the macro-blocks in the previous frame and a macro-block in a current frame can be calculated using a specified measurement method to find a macro-block most similar to the macro-block in the current frame.

According to an example of the specified measurement method, differences between pixel values in the macro-block of a current frame and pixel values in the macro-blocks of the search area are calculated. Then, absolute values of the differences are taken and added. A macro-block having the smallest value obtained as a result of the addition is determined as the most similar macro-block.

Specifically, a degree of similarity between the macro-blocks in the current and previous frames is determined based on a similarity value, i.e., a matched reference value, which is calculated using pixel values included in the macro-blocks of the current and previous frames. The similarity value, i.e., the matched reference value, is calculated using a specified measurement function. Examples of the measurement function include a sum of absolute differences (SAD), a sum of absolute transformed differences (SATD), and a sum of squared differences (SSD).

However, a considerable amount of calculation is required to produce such matched reference values, entailing a lot of hardware resources to encode video data in real time. In an effort to reduce the amount of calculation required for motion estimation, so-called hierarchical motion estimation has been studied. In hierarchical motion estimation, an original frame is divided into frames with various degrees of resolution, and motion vectors of frames for each degree of resolution are created in a hierarchical manner. One of the known methods of hierarchical motion estimation is a multi-resolution multiple candidate search.

Depending on the scope of a search, the search is categorized into a full search and a local search. The full search searches the entire search area whereas the local search searches a part of the search area.

FIG. 1 illustrates conventional hierarchical motion estimation. Referring to FIG. 1, for the hierarchical motion estimation, each of a current frame to be encoded and a previous frame is divided into a lower level 104 having an original degree of resolution, a middle level 102 having a degree of resolution reduced by decimating an image of the lower level 104 by half, and an upper level 100 having a degree of resolution reduced by decimating an image of the middle level by half. In this hierarchical motion estimation, motion estimation is performed using images with different degrees of resolution and different search scopes per level. Thus, high-speed motion estimation is possible.

The conventional hierarchical motion estimation will now be described in more detail. It is assumed that motion estimation is conduced in units of 16×16 macro-bocks and a search area is [−16, +16]. In the upper level 100, a macro-block most similar to a current 4×4 macro-block in the current frame, which is a quarter of the size of an original macro-block, is searched for in the previous frame. Here, the search area is [−4, +4], which is a quarter of the original search area.

Generally, a SAD function is used to measure a matched reference value, that is, a degree of similarity. The SAD value is obtained by subtracting pixel values of a search macro-block from those of the current 4×4 macro-block, taking absolute values of the subtracted values, and adding all of the absolute values. In this way, macro-blocks most and second most similar to the current 4×4 macro-block in the current frame are found in the previous frame, and motion vectors for the two cases are obtained.

In the middle level 102, the search area is half the size of the original search area. That is, a search area of [−2, +2] in the previous frame is searched based on three search points. The three search points refer to two search points corresponding to the two motion vectors obtained in the upper level 100 and one search point indicated by a predicted motion vector (PMV) obtained by taking the median of motion vectors of three macro-blocks located to the left, top, and top-right of the current macro-block. The three macro-blocks have already been encoded and their motion vectors have already been decided. In the middle level 102, a macro-block most similar to the current macro-block and a motion vector corresponding to the macro-block are obtained by searching the search area of [−2, +2].

In the lower level 104, that is, in the previous frame of the original size, the search area of [−2, +2] is partly searched based on a search point corresponding to the macro-block found in the middle level 102, i.e., a top-left apex of the macro-block. Then, a macro-block most similar to the current macro-block and a motion vector corresponding to the macro-block are obtained. In doing so, the search area is reduced, thereby decreasing the amount of time and hardware resources required.

Most of the conventional moving-image standards are adopting a field motion estimation mode as well as a frame motion estimation mode to support interlaced scanning. In particular, H.265 and MPEG-2 support a macro-block adaptive frame field (MBAFF) mode in which frame motion estimation and field motion estimation are conducted in units of macro-blocks, not pictures.

However, if the hierarchical motion estimation is applied to a moving-image standard that supports the MBAFF, matched reference values must be additionally calculated whenever conducting frame motion estimation and field motion estimation in middle and lower levels. In this case, the amount of calculation required increases sharply.

### BRIEF SUMMARY

An aspect of the present invention provides a motion estimation apparatus and method, which enables efficient motion estimation for frames and fields of each level.

According to an aspect of the present invention, there is provided a motion estimation apparatus including: a pixel data storing unit storing pixel data of a block to be searched for and pixel data of blocks in a search area; a two-dimensional processing element array receiving pixel data from the pixel data storing unit and calculating degrees of similarity between the block to be searched for and the blocks in the search area; a merging and comparing unit merging the degrees of similarity, generating degrees of similarity for blocks of various sizes, comparing the generated degrees of similarity, and outputting motion vectors for the blocks of various sizes;

and an address controlling unit controlling an address of the pixel data storing unit such that the pixel data of the pixel data storing unit can be sequentially transmitted to the two-dimensional processing element array.

The pixel data storing unit may store pixel data of an original frame in which the block to be searched for is included and a target frame in which the search area is included, and the resolution of the original frame and the target frame may be respectively reduced to half and a quarter of their original resolution.

The pixel data storing unit may include a search target macro-block storing unit storing the pixel data of the block to search in a 4×1-pixel register array; and a search area macro-block data storing unit storing the pixel data of the blocks in the search area in an 11×1-pixel register array.

The search area macro-block data storing unit may be a dual port memory to alternately output the pixel data of the blocks in the search area to different ports of the dual port memory at specified clock cycles.

The processing element array may calculate the degrees of similarity in 4×8-pixel block units in an upper level in which the resolution of the original frame and the resolution of the target frame are reduced to a quarter of their original resolution and calculate the degrees of similarity in 4×4 block units in a middle level in which the resolution of the original frame and the resolution of the target frame are reduced to half of their original resolution.

According to another aspect of the present invention, there is provided a motion estimation method including: receiving pixel data of a block to be searched for and pixel data of blocks in a search area and calculating degrees of similarity between the block to be searched for and the blocks in the search area; and merging the degrees of similarity, generating degrees of similarity for blocks of various sizes, comparing the generated degrees of similarity, and outputting motion vectors for the blocks of various sizes.

In the receiving of the pixel data and the calculating of the degrees of similarity, the degree of similarity for each level may be calculated using pixel data of an original frame in which the block to search for is included and a target frame in which the search area is included, and the resolution of the original frame and the target frame may be reduced to half and a quarter of their original resolution.

The pixel data of the blocks in the search area may be alternately output to different ports of a dual port memory at specified clock cycles.

In the receiving of the pixel data and the calculating of the degrees of similarity, N×N processing elements may be used to calculate the degrees of similarity, and the degrees of similarity for N×N search points may be calculated simultaneously.

According to another aspect of the present invention, there is provided a motion estimation apparatus including: a pixel data storing unit including a search target macro-block data storing unit storing pixel data of a macro-block in a current frame, and a search area macro-block data storing unit storing pixel data of macro-blocks in a search area of a frame to be searched; a two-dimensional processing element array receiving pixel data from the pixel data storing unit and calculating a degree of similarity between the macro-block in the current frame and macro-blocks in the search area; a merging and comparing unit merging the degree of similarity, generating degrees of similarity values corresponding to various block sizes, comparing the generated degrees of similarity, and outputting motion vectors for the blocks of various sizes; and an address controlling unit determining an address to read in order to retrieve pixel data needed to calculate the degree of similarity from the pixel data storing unit and outputting the address is input to the two-dimensional processing element array.

According to another aspect of the present invention, there is provided a method of reducing wasted clock cycles in hierarchal motion estimation, including: storing in a storage section pixel data of a block to be searched for and pixel data of blocks in a search area; receiving pixel data from the pixel data storing unit and calculating, via a two-dimensional processor, degrees of similarity between the block to be searched for and the blocks in the search area; merging the degrees of similarity, generating degrees of similarity for blocks of various sizes, comparing the generated degrees of similarity, and outputting motion vectors for the blocks of various sizes; and sequentially transmitting the pixel data to the two-dimensional processing element array by controlling a address of the storage section.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 illustrates conventional hierarchical motion estimation;

FIG. 2 is a block diagram of a motion estimation apparatus according to an embodiment of the present invention;

FIG. 3 is a detailed block diagram of the motion estimation apparatus of FIG. 2;

FIG. 4 illustrates the structure of a two-dimensional processing element (PE) array according to an embodiment of the present invention;

FIG. 5 illustrates a detailed configuration of a PE;

FIG. 6A illustrates search points processed by a PE array in an upper level;

FIG. 6B illustrates search points processed by the PE array in a middle level;

FIG. 6C illustrates search points processed by the PE array in a lower level;

FIGS. 7A through 7C illustrate the connection between the two-dimensional PE array and an SRAM storing pixel data in a search area;

FIG. 8 illustrates a search block and a search area processed in the upper level;

FIG. 9 illustrates the pixel data of the search area, which is input to PE (n, 0) in the upper level;

FIGS. 10A through 10C illustrate the order of processing pixel data by a PE by dividing the search area in the upper level;

FIG. 11 illustrates a search block and a search area processed in the middle level;

FIG. 12 illustrates the pixel data in the search area, which is input to PE (n, 0) in the middle level;

FIG. 13 illustrates a search block and a search area processed in the lower level; and

FIG. 14 illustrates the pixel data in the search area, which is input to PE (n, 0) in the lower level.

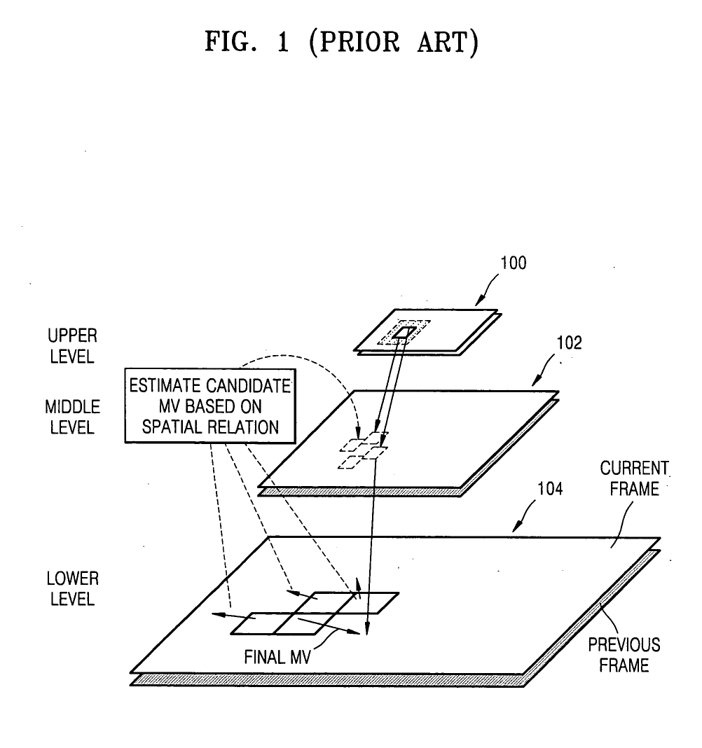

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

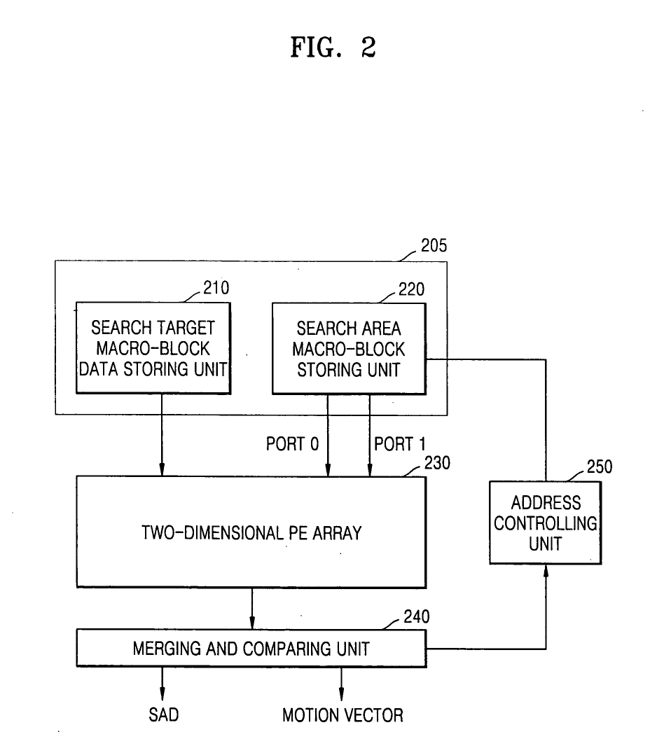

FIG. 2 is a block diagram of a motion estimation apparatus according to an embodiment of the present invention. Referring to FIG. 2, the motion estimation apparatus includes a pixel data storing unit 205, a two-dimensional processing element (PE) array 230, a merging and comparing unit 240, and an address controlling unit 250.

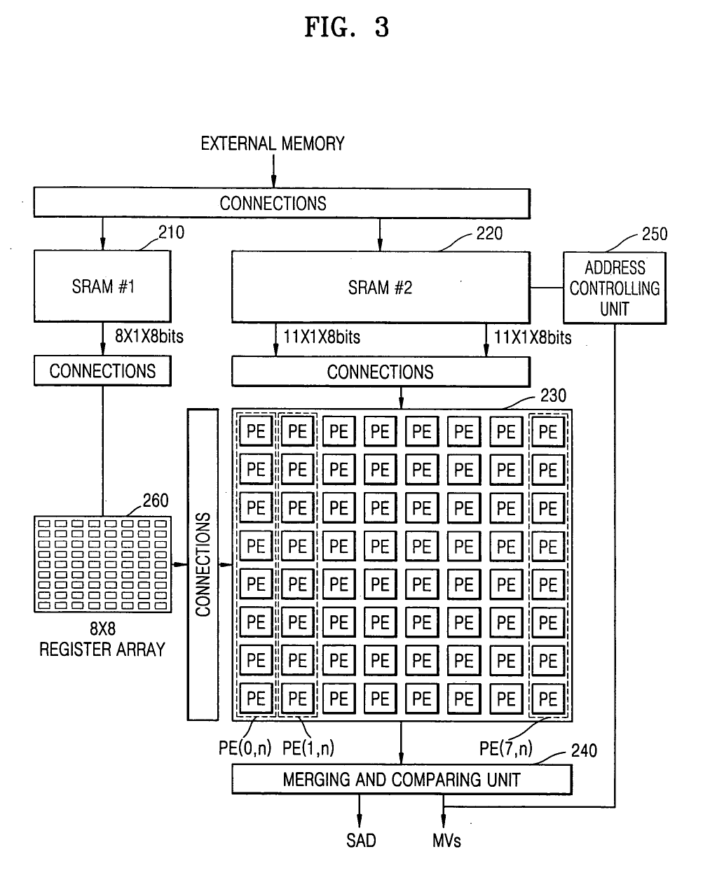

The pixel data storing unit 205 includes a search target macro-block data storing unit 210 storing pixel data of a macro-block in a current frame, i.e., pixel data of a search target macro-block, and a search area macro-block data storing unit 220 storing pixel data of macro-blocks in a search area of a frame to be searched. The search target macro-block data storing unit 210 may be an SDRAM. A detailed description of the search target macro-block data storing unit 210 will be made later with reference to FIG. 3. The search area macro-block data storing unit 220 may be implemented as a dual port memory to efficiently transmit pixel data in a search area to the two-dimensional PE array 230.

The two-dimensional PE array 230 includes 8×8 PEs. The two-dimensional PE array 230 receives pixel data from the pixel data storing unit 205 and calculates a degree of similarity between the macro-block in the current frame and the macro-blocks in the search area such that a macro-block most similar to the macro-block in the current frame can be found in the search area.

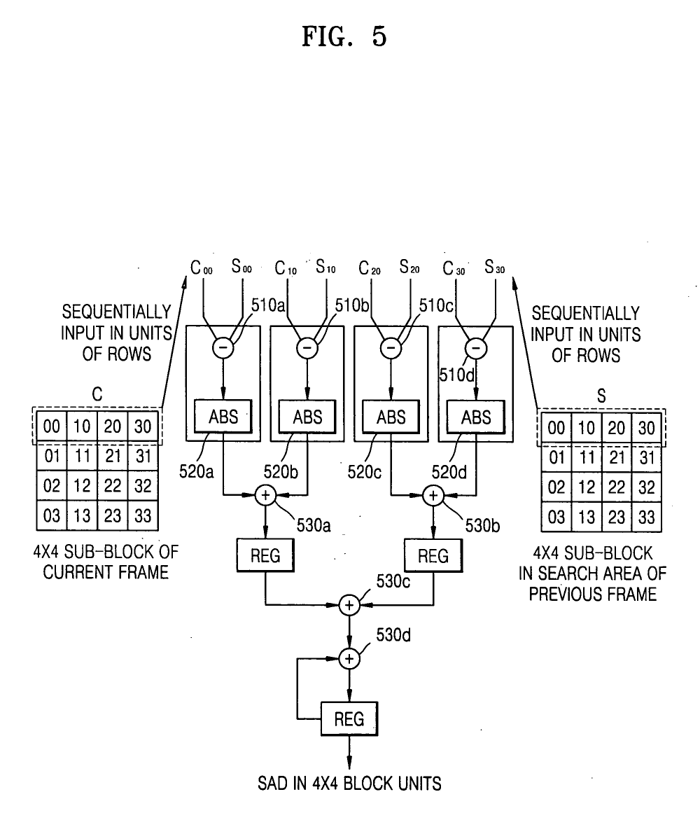

In the present embodiment, since a degree of similarity is described using a sum of absolute differences (SAD), and a SAD value is calculated. Since the two-dimensional PE array 230 includes 8×8 PEs, SAD values for a plurality of search points can be calculated at a time. Here, SAD values are calculated in 4×8 units or 4×4 units according to a level at which SAD calculations are performed. A method of calculating a degree of similarity, i.e., the SAD, using one PE will be described later with reference to FIG. 5.

The merging and comparing unit 240 merges calculated SAD values and creates SAD values corresponding to various block sizes used in H.264, for example, 16×16, 16×8, 8×16, 8×8, 8×4, 4×8, and 4×4. When estimating motion in units of fields, since a frame includes a top field and a bottom field, a block size used in the motion estimation is 16×32. In the present embodiment, since the resolution of the frame is reduced to half or a quarter of its original resolution, a block size used in the motion estimation is 8×16 or 4×8 for each level. Therefore, a SAD value corresponding to a block of a desired size can be created by merging SAD values calculated in 4×8 or 4×4 block units. Using the SAD value, an optimal motion vector is output.

The address controlling unit 250 determines an address to read in order to retrieve pixel data needed to calculate SADs from the pixel data storing unit 205 such that the address is input to the two-dimensional PE array 230.

FIG. 3 is a detailed block diagram of the motion estimation apparatus of FIG. 2. The search target macro-block data storing unit 210 and the search area macro-block data storing unit 220 may be SRAMs. The search target macro-block data storing unit 210 sequentially transmits eight 8-bit data values to an 8×8 register array 260 in synchronization with a system clock. In every clock cycle, the 8×8 register array 260 transmits pixel data stored in each row of the register array 260 to registers in respective next rows of the register array 260. The 8×8 register array 260 is connected to the two-dimensional PE array 230 in units of rows and sequentially transmits pixel data of a search target macro-block to the two-dimensional PE array 230.

In other words, 8 registers in a first row of the 8×8 register array 260 are connected to PEs in a first row of the two-dimensional PE array 230, and registers in a second row of the 8×8 register array 260 are connected to PEs in a second row of the two-dimensional PE array 230. Thus, the pixel data of the search target macro-block input to PEs in each row of the two-dimensional PE array 230 has been delayed from one another by one clock cycle.

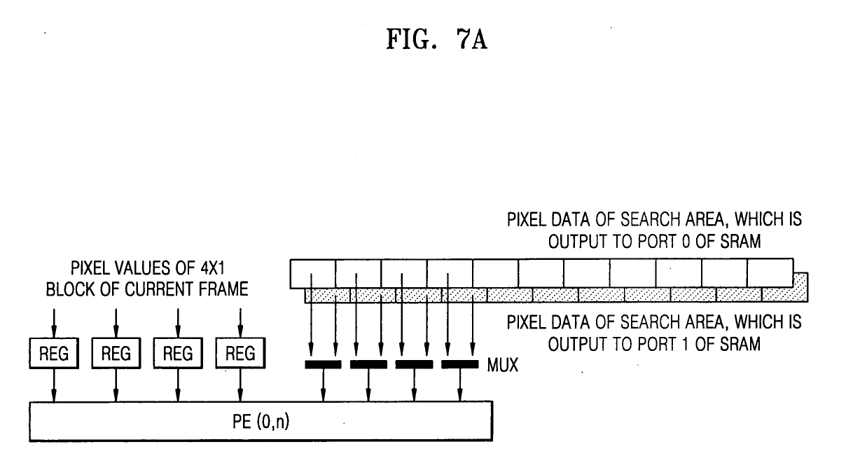

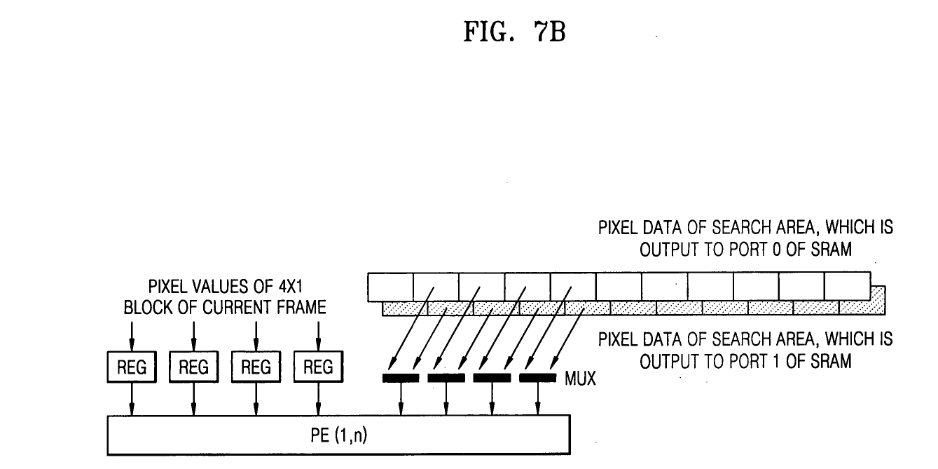

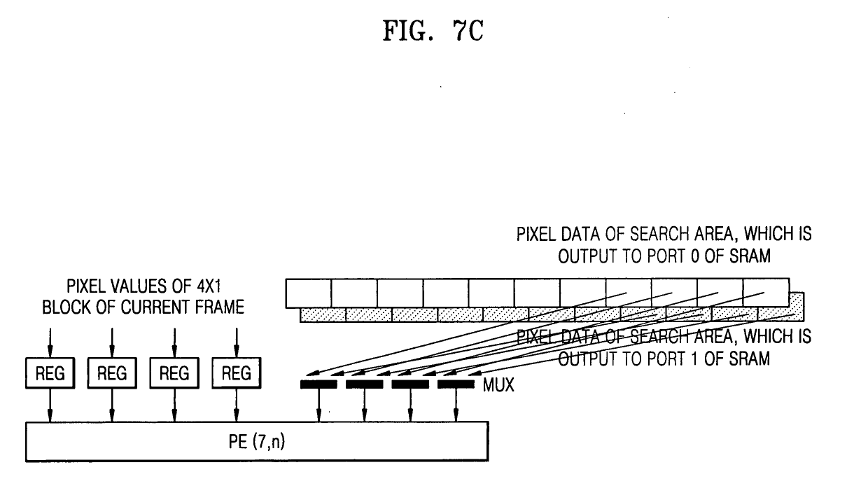

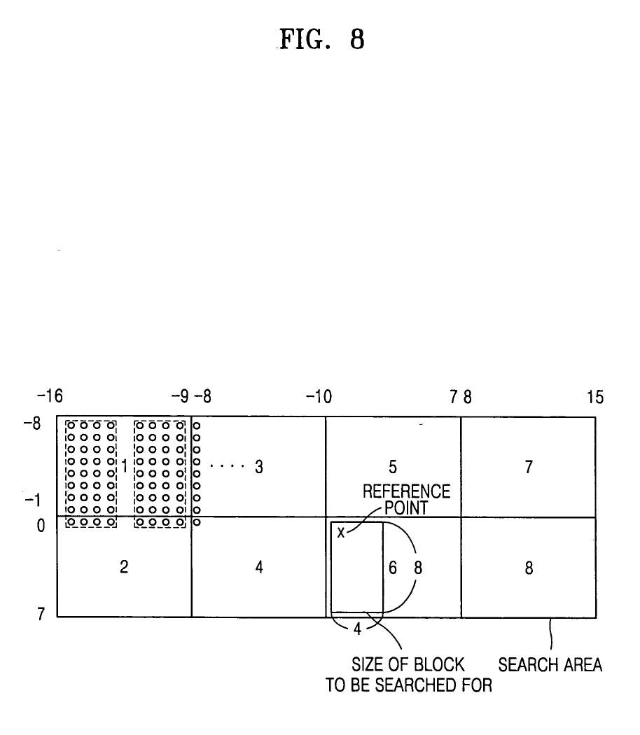

The search area macro-block data storing unit 220 in which the pixel data of the macro-blocks in the search area is stored is a dual port SRAM. SDRAM, which has two ports, consists of registers of 11×8 bits, and eight of the registers are selectively connected to PEs of the two-dimensional PE array 230 in units of rows, and thus pixel data stored in the eight registers is input to the two-dimensional PE array 230. The connection state with the registers varies for each row of the two-dimensional PE array 230, and all the pixel data of the SDRAM is input to the 8×8 PEs simultaneously. Here, the pixel data of the search area is output to different ports every 16 clock cycles so as not to waste time. The connection between the search area macro-block data storing unit 220 and the two-dimensional PE array 230 will be described later with reference to FIGS. 7A through 8C.

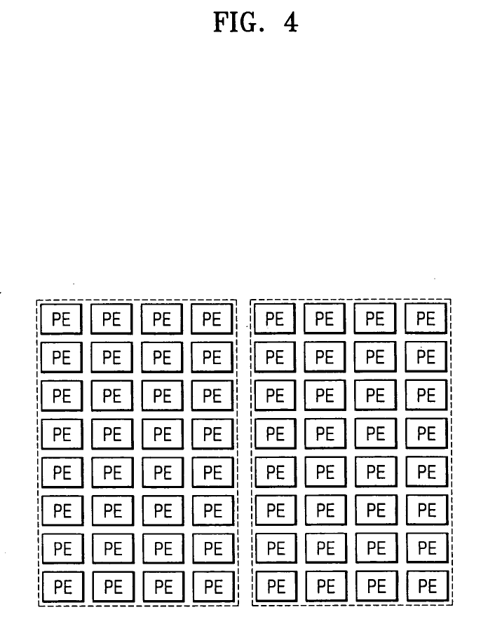

FIG. 4 illustrates the structure of a two-dimensional PE array according to an embodiment of the present invention. The two-dimensional PE array includes 8×8 PEs. Each PE calculates one SAD for each level, at which SAD calculations are performed, in 4×8 or 4×4 units. Alternatively, one PE may calculate a SAD for one search point or two PEs may calculate a SAD for one search point.

FIG. 5 illustrates a detailed configuration of a PE. A PE calculates a SAD value in 4×4 block units. A PE includes four subtractors 510a through 510d, four absolute-value calculators 520a through 520d, and four adders 530a through 530d. The PE receives pixel data of a 4×4 block in units of rows. The PE reads C₀₀, C₁₀, C₂₀, and C₃₀, which are pixel values in a first row of a 4×4 block in a current frame, and S₀₀, S₁₀, S₂₀, and S₃₀, which are pixel values in a first row of a 4×4 block in a search area of a previous frame, and subtracts S₀₀, S₁₀, S₂₀, and S₃₀ from C₀₀, C₁₀, C₂₀, and C₃₀. Then, the PE takes absolute values of the subtracted pixel values and adds the absolute values.

In a next clock cycle, the PE reads C₀₁, C₁₁, C₂₁, and C₃₁, which are pixel values in a second row of the 4×4 block in the current frame, and S₀₁, S₁₁, S₂₁, and S₃₁, which are pixel values in a second row of the 4×4 block in the search area of the previous frame, and subtracts S₀₁, S₁₁, S₂₁, and S₃₁ from C₀₁, C₁₁, C₂₁, and C₃₁. Then, the PE takes absolute values of the subtracted pixel values and adds the absolute values. A value obtained as a result of the addition is added to a value obtained as a result of the previous addition. The process described above is repeated until a fourth clock cycle passes. After the fourth clock cycle passes, the calculation of the SAD value for the 4×4 block is complete.

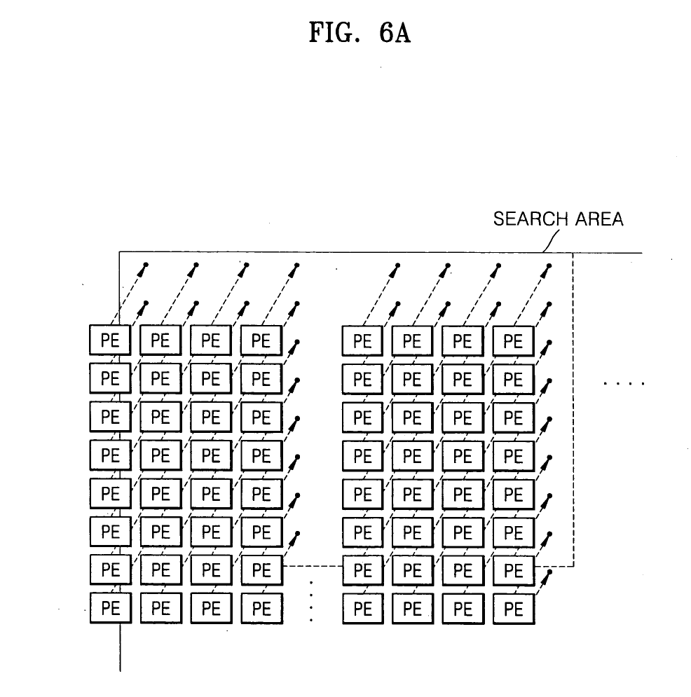

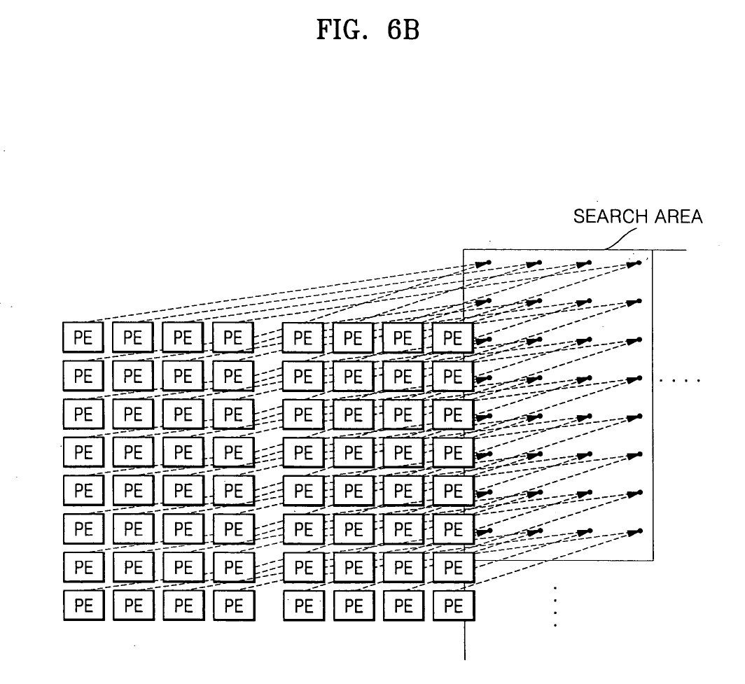

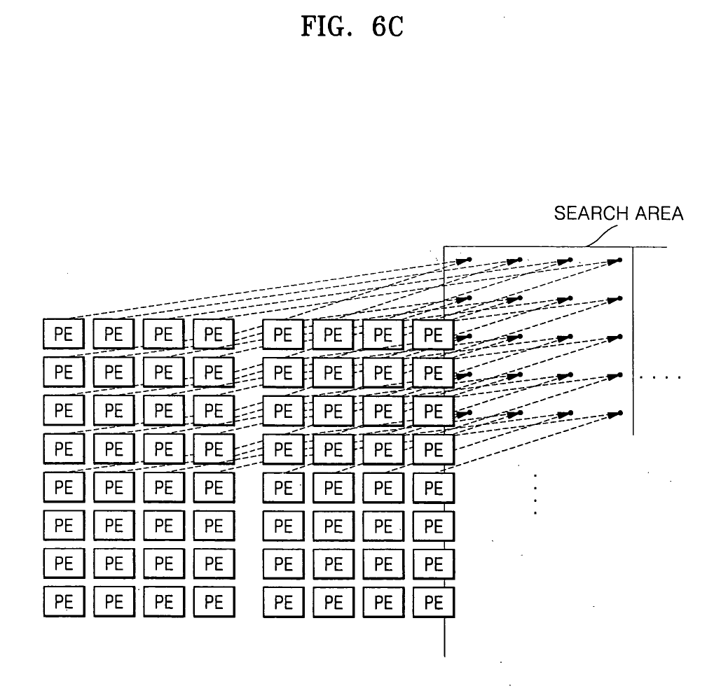

FIG. 6A illustrates search points processed by a PE array in an upper level. FIG. 6B illustrates search points processed by the PE array in a middle level. FIG. 6C illustrates search points processed by the PE array in a lower level.

Referring to FIG. 6A, one PE processes one search point since, in the upper level, motion estimation is performed only in units of frames. In other words, a SAD is calculated for a search area, which is reduced to a quarter of its original size. Referring to FIG. 6B, in the middle level, a frame is divided into a top field and a bottom field for motion estimation. Thus, two PEs process one search point. One PE calculates a SAD value for the top field in 4×4 block units while the other PE calculates a SAD value for the bottom field in 4×4 block units. By merging the SAD values calculated by the two PEs, SAD values for a top field ME, a bottom field ME, and four field MEs (a top-top field ME, a top-bottom field ME, a bottom-bottom field ME, and a bottom-top field ME) can be obtained. Likewise, referring to FIG. 6C, in the lower level, two PEs process one search point.

FIGS. 7A-7C illustrates the relationship between the two-dimensional PE array 230 of FIG. 3 and the search area macro-block data storing unit 220 of FIG. 3 storing pixel data in the search area. Referring to FIGS. 3 and 7A, pixel values of a 4×1 macro-block in the current frame are sequentially input to PE (0, n) in the first row of the two-dimensional PE array 230 via registers. Registers storing pixel data in the search area are 11×8 bit registers. First each of four pixel values is input to the PE (0, n) via a multiplexer (MUX). The other input port of the MUXs are connected to data output from port 1 of the SRAM storing the pixel data in the search area. For time efficiency, the pixel data in the search area is repeatedly output to port 0 and port 1 of the SRAM, in turns, for every 16 clock cycles. Therefore, the MUX switches to a port from which pixel data in a current search area is output and connects the port to the PE (0, n).

Referring to FIGS. 3 and 7B, four pixel values from the second pixel value in the 11×8 register storing the pixel values of the search area are connected to PE (1, n) in the second row of the two-dimensional PE array 230 through the MUX. In this way, as shown with reference to FIGS. 3 and 7C, a PE (7, n) in an eighth row, which is the last row of the two-dimensional PE array 230, is connected to the last four pixel values of the 11×8 register through the MUX.

FIG. 8 illustrates a search block and a search area processed in the upper level. In the upper level, since an original frame was decimated to a quarter of its original size, the size of a macro-block to be searched is 4×8, which is a quarter of an original macro-block, i.e., 16×32. Accordingly, the size of a search area is decimated to a matrix measuring [−16, +15] horizontally and [−8, 7] vertically, which is a quarter of an original search area, i.e., [−64, +63] horizontally and [−32, +31] vertically.

The two-dimensional PE array 230 processes this search area. Since the two-dimensional PE array 230 includes 8×8 PEs and one PE processes one search point in the upper level, as illustrated in FIG. 8, the search area is divided into 8×8 units and processed accordingly. If the search area is divided into 8×8 units, eight search areas are created. Since only one 8×8 search area can be processed at a time, the eight search areas are processed in a numeric order illustrated in FIG. 8.

Pixel data in the search area, which is input to the PEs and the way in which the pixel data is processed in the upper level will now be described in detail. To calculate a SAD for (−16, −8), which is a first search point in the search area of [−16, 15] and [−8, 7], pixel values in the search area, which are input to PE (0, 0), are 4×8 pixels based on (−16, −8). As illustrated in FIG. 5, since one PE compares four pixel values in the target block of the current frame with four pixel values in the search area of the previous frame at a time, it takes eight clock cycles to calculate the SAD for the 4×8 search block. Thus, only after the eight clock cycles pass is the calculation of the SAD for the 4×8 block is complete for the search point of (−16, −8).

Similarly, pixel values in the search area, which are input to PE (1, 0), are 4×8 pixels based on (−15, −8), which is a second search point, to calculate the SAD for (−15, −8). In this way, when moving the macro-blocks sideways by one pixel, pixel values in the search area, which are input to PE (7, 0), are 4×8 pixels based on (−9, −8).

Moving downwards, to calculate the SAD for the 4×8 block at (−16, −7), pixel values in the search area are input to PE (0, 1), and to calculate the SAD for the 4×8 block at (−15, −7), pixel values in the search area are input to PE (1, 1). Thus, one PE can calculate the SAD for the 4×8 block at each search point, moving the macro-blocks downwards by one pixel. Then, the SAD for a first 8×8 search area indicated by 1 in FIG. 8 can be calculated at one time. In this way, the SAD for the 4×8 block at each search point can be calculated in second through eighth search areas.

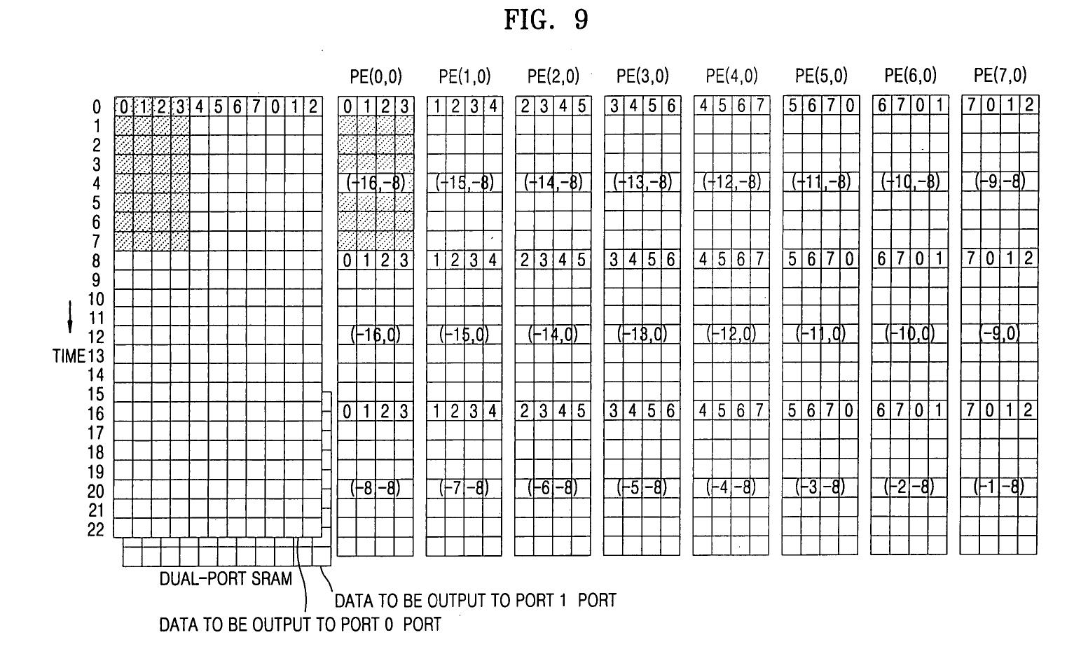

FIG. 9 illustrates the pixel data of the search area, which is input to PE (n, 0) in the upper level. Referring to FIG. 9, it can be seen that the pixel data of the search area is stored in an 11×23 register. In FIG. 9, the time axis points in a downward direction. Of the pixel data stored in the SRAM, four pixel data values at a time are sequentially input to each PE for every clock cycle. After 8 clock cycles, the SAD for the 4×8 search block at one search point is complete. Also, another 11×23 register is available such that the pixel data can be output to ports 0 and 1 of the SRAM, and the pixel data of the 11×23 register is output to the port 1. There is a 16-clock cycle difference between pixel data output to the ports 0 and 1.

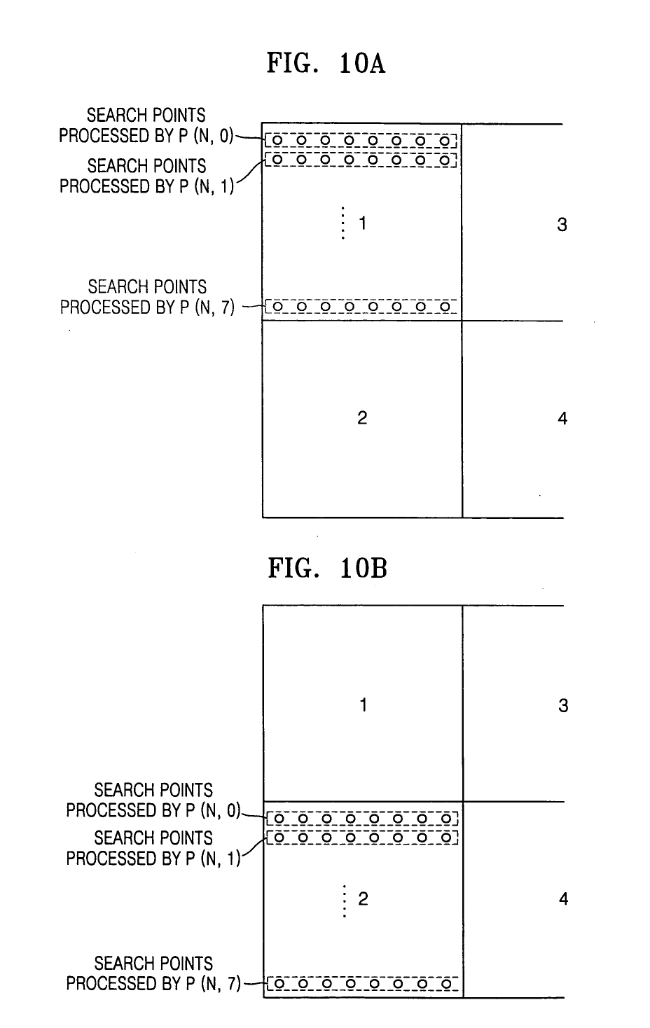

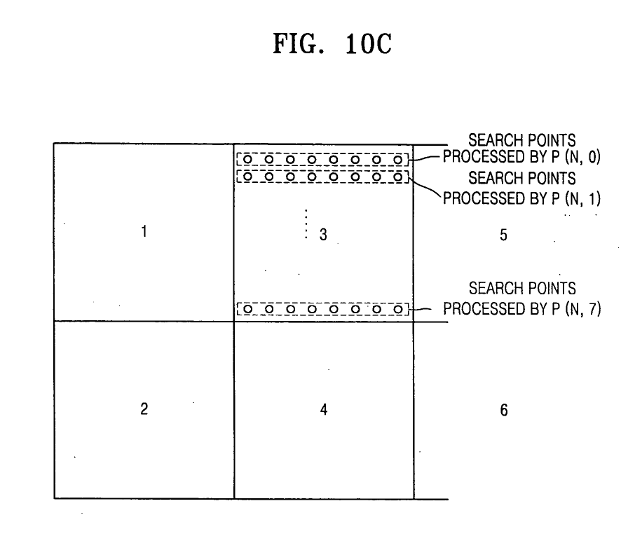

FIGS. 10A through 10C illustrate the order of processing pixel data by a PE by dividing the search area in the upper level. That is, FIGS. 10A through 10C illustrate search points processed by each PE in each area when the search area is divided into 8 areas. It can be seen that each PE processes one search point.

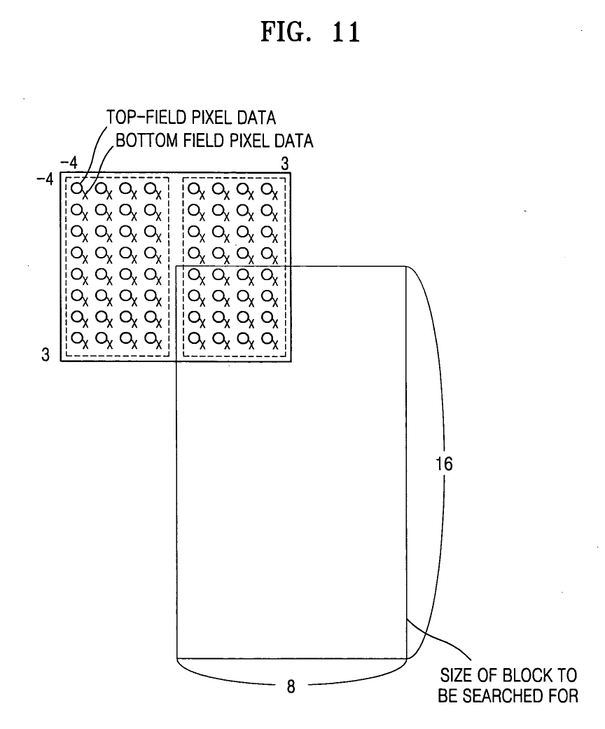

FIG. 11 illustrates a search block and a search area processed in the middle level. Since the original frame was decimated by half in the middle level, the size of a macro-block to be searched is 8×16, which is half the size of the original macro-block, i.e., 16×32. In the middle level, not a full but a local search is conducted. Therefore, the search area is [−4, 3] and [−4, 3]. Also, in the middle level, motion estimation is performed in units of fields, each including a top field and a bottom field. In FIG. 11, “o” denotes top-field pixel data and “x” denotes bottom-field pixel data.

In the middle level, for MBAFF coding, two frame MEs for an 8×8-frame top block and an 8×8-frame bottom block and four field MEs (top2top field ME, top2bottom field ME, bottom2top field ME, and bottom2bottom field ME) for an 8×8 field top block and an 8×8-field bottom block are performed to obtain six motion vectors. Since the macro-block most similar to the macro-block in the current frame and two motion vectors are obtained in the upper level and delivered to the middle level, 12 motion vectors, in fact, are obtained.

The pixel data of the macro-block in the current frame and the pixel data of the macro-blocks in the search area, which are input to the two-dimensional PE array 230, are identical to the pixel data used to perform a frame ME in the search area of [−4, 3] horizontally and vertically for an 8×16 block. However, PEs calculate SADs in 4×4 field units and, by combing the SADs, obtain a SAD for two frame MEs and four field MEs. In other words, in the middle level, since the SADs are calculated in 4×4-field block units, two PEs are responsible for one search point and obtains the SADs for the 8×4-field blocks as illustrated in FIG. 6B. By merging the SADs for the 8×4-field blocks, the SAD for the 8×8-frame block and the SAD for the 8×8-field block can be obtained.

The pixel data in the search area, which is input to the PEs in the middle level, and how the pixel data is processed will now be described in detail. To calculate the SAD for (−4, −4), which is a first search point in the search area of [−4, 3] and [−4, 3], 4×16-pixel data in the search area is input to PE (0, 0). Then, four SADs for 4×4 fields are calculated. Likewise, to calculate the SAD for (−3, −4), which is a second search point, 4×16 pixel data in the search area is input to PE (1, 0) and four SADs for 4×4 fields are calculated.

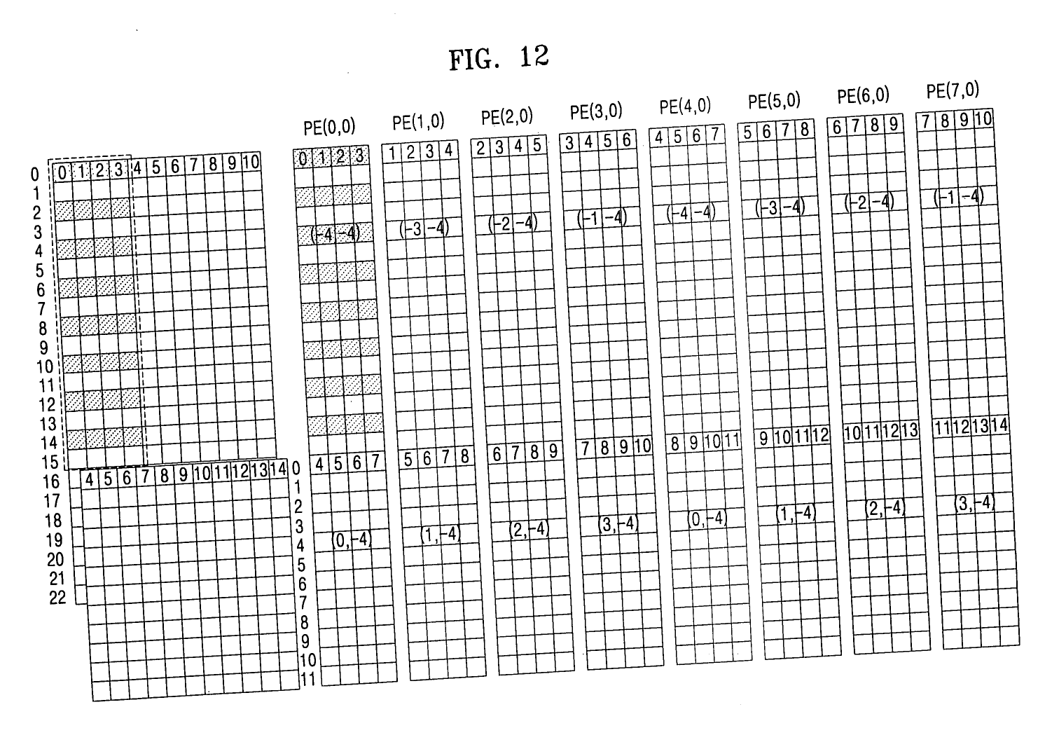

FIG. 12 illustrates pixel data in the search area, which is input to PE (n, 0) in the middle level. Referring to FIG. 12, it can be seen that, as in the upper level, the pixel data of the search area is input to the 11×23 register. In FIG. 12, the time axis points in a downward direction. Of the pixel data stored in the SRAM, four pixel data values at a time are sequentially input to each PE for every clock cycle. After 8 clock cycles, the SAD for the 4×4 search block at a search point is complete for the top field and the bottom field. Also, another 11×23 register is available such that the pixel data can be output to port of the SRAM, and the pixel data of the 11×23 register is output to port 1 of the SDRAM. There is a 16-clock cycle difference between pixel data output to the ports 0 and 1.

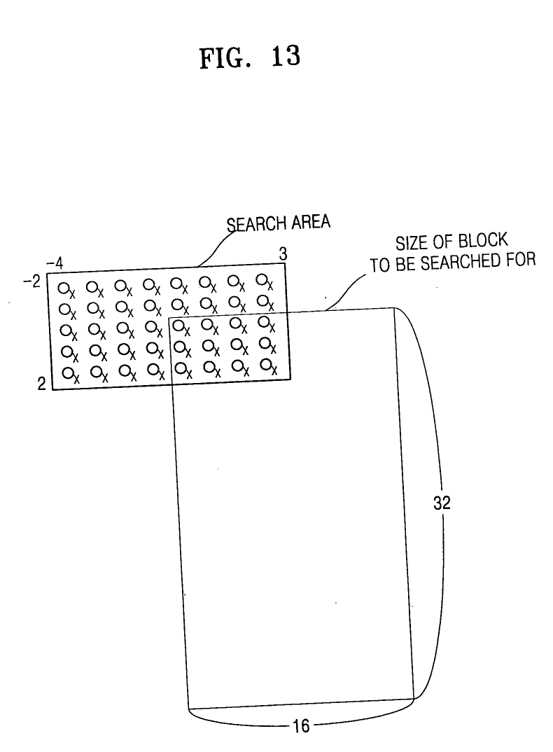

FIG. 13 illustrates a search block and a search area processed in the lower level. In the lower level, since the size of the original frame is maintained, the size of a macro-block to be searched is 16×32, which is the size of the original macro-block. However, the full search is not conducted in the lower level. Rather, the local search is conducted in [−4, 3] and [−2, 2]. As in the middle level, motion estimation is performed in units of fields, i.e., the top field and the bottom field, in the lower level.

In other words, in the lower level, for the MBAFF coding, two frame MEs for a 16×16 frame top block and a 16×16 frame bottom block and four field MEs (top2top field ME, top2bottom field ME, bottom2top field ME, and bottom2bottom field ME) for a 16×16 field top block and a 16×16 field bottom block are performed to obtain six motion vectors. As in the middle level, in the lower level, the SADs are calculated in 4×4-field block units, and two PEs are responsible for one search point. However, unlike the middle level, the two PEs calculate the SADs for different 4×4-field blocks at the same search point, as illustrated in FIG. 6C. By merging eight SADs for the 4×4-field blocks, one SAD for a 16×32 block can be obtained.

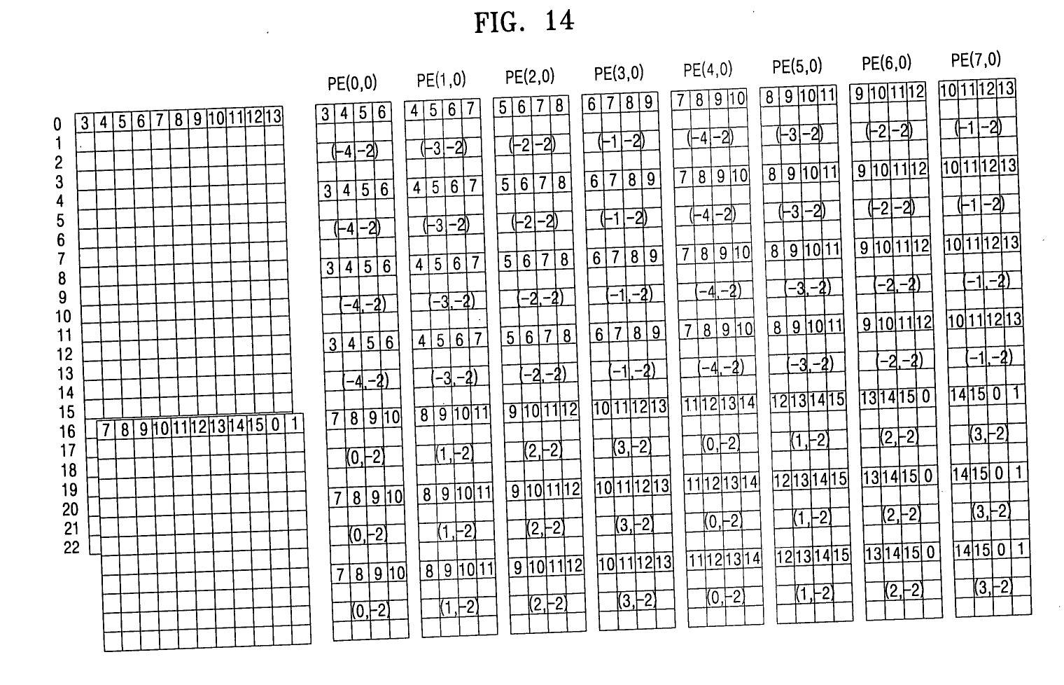

FIG. 14 illustrates pixel data in the search area, which is input to PE (n, 0) in the lower level. Referring to FIG. 14, it can be seen that, as in the middle and upper levels, the pixel data of the search area is stored in the 11×23 register. In FIG. 14, the time axis points in a downward direction. Of the pixel data stored in the SRAM, four pixel data values at a time are sequentially input to each PE for every clock cycle. After 8 clock cycles, the SAD for the 4×4 search block at a search point is complete for the top field and the bottom field. Also, another 11×23 register is available such that the pixel data can be output to port of the SRAM, and the pixel data of the 11×23 register is output to port 1 of the SDRAM. There is a 16-clock cycle difference between pixel data output to ports 0 and 1.

In hierarchical motion estimation according to the above-described embodiment of the present invention, each level has a different degree of resolution and search area, and pixel data of a search area is stored in a dual-port memory. Thus, wasted clock cycles can be reduced, and motion estimation can be performed on blocks of various sizes.

The present invention can also be implemented as a computer program.

Also, the program can be recorded on a computer-readable medium, which can be thereafter read and executed by a computer system. Examples of the computer-readable medium include magnetic recording media, optical recording media, and carrier waves.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A motion estimation apparatus comprising:
a pixel data storing unit storing pixel data of a block to be searched for and pixel data of blocks in a search area;
a two-dimensional processing element array receiving pixel data from the pixel data storing unit and calculating degrees of similarity between the block to be searched for and the blocks in the search area;
a merging and comparing unit merging the degrees of similarity, generating degrees of similarity for blocks of various sizes, comparing the generated degrees of similarity, and outputting motion vectors for the blocks of various sizes; and
an address controlling unit controlling an address of the pixel data storing unit such that the pixel data of the pixel data storing unit is sequentially transmitted to the two-dimensional processing element array.

2. The apparatus of claim 1, wherein the pixel data storing unit also stores pixel data of an original frame which includes the block to be searched for and a target frame which includes the search area, and the resolution of the original frame and the target frame are respectively reduced to a half and a quarter of their original resolution.

3. The apparatus of claim 1, wherein the pixel data storing unit includes:
a search target macro-block storing unit storing the pixel data of the block to be searched in a 4×1-pixel register array; and
a search area macro-block data storing unit storing the pixel data of the blocks in the search area in an 11×1-pixel register array.

4. The apparatus of claim 3, wherein the first four registers from a first row of the 11×1-pixel register array of the search area macro-block data storing unit are connected to processing elements in a first row of the two-dimensional processing element, and a next four registers excluding the first one register are connected to processing elements in a second row of the two-dimensional processing element.

5. The apparatus of claim 3, wherein the search area macro-block data storing unit is formed of a dual port memory to alternately output the pixel data of the blocks in the search area to different ports of the dual port memory at specified clock cycles.

6. The apparatus of claim 1, wherein the block to search for is a 16×32-pixel macro-block adaptive frame field.

7. The apparatus of claim 1, wherein the processing element array includes N×N processing elements arranged in a matrix form.

8. The apparatus of claim 7, wherein N is eight.

9. The apparatus of claim 1, wherein the processing element array calculates the degrees of similarity in 4×8-pixel block units in an upper level in which the resolution of the original frame and the resolution of the target frame are reduced to a quarter of their original resolution and calculates the degrees of similarity in 4×4 block units in a middle level in which the resolution of the original frame and the resolution of the target frame are reduced to half of their original resolution.

10. The apparatus of claim 9, wherein the merging and comparing unit merges the degrees of similarity calculated in the 4×4-pixel block units in the middle level and calculate degrees of similarity for the blocks of various sizes and motion vectors corresponding to the calculated degrees of similarity.

11. A motion estimation method comprising:
receiving pixel data of a block to be searched for and pixel data of blocks in a search area and calculating degrees of similarity between the block to be searched for and the blocks in the search area; and
merging the degrees of similarity, generating degrees of similarity for blocks of various sizes, comparing the generated degrees of similarity, and outputting motion vectors for the blocks of various sizes.

12. The method of claim 11, wherein, in the receiving of the pixel data and the calculating of the degrees of similarity, the degree of similarity for each level is calculated using pixel data of an original frame which includes the block to be searched for and a target frame which includes the search area, and the resolution of the original frame and the target frame are respectively reduced to a half and a quarter of their original resolution.

13. The method of claim 11, wherein the pixel data of the blocks in the search area is alternately output to different ports of a dual port memory at specified clock cycles.

14. The method of claim 11, wherein, in the receiving of the pixel data and the calculating of the degrees of similarity, N×N processing elements are used to calculate the degrees of similarity, and the degrees of similarity for N×N search points are calculated simultaneously.

15. The method of claim 11, wherein, in the receiving of the pixel data and the calculating of the degrees of similarity, the degrees of similarity are calculated in 4×8-pixel block units in an upper level in which the resolution of the original frame and the resolution of the target frame are reduced to a quarter of their original resolution and the degrees of similarity are calculated in 4×4 block units in a middle level in which the resolution of the original frame and the resolution of the target frame are reduced to half of their original resolution.

16. A computer-readable recording medium on which a program causing a processor to execute a motion estimation method, the method comprising:
receiving pixel data of a block to be searched for and pixel data of blocks in a search area and calculating degrees of similarity between the block to be searched for and the blocks in the search area; and
merging the degrees of similarity, generating degrees of similarity for blocks of various sizes, comparing the generated degrees of similarity, and outputting motion vectors for the blocks of various sizes.

17. A motion estimation apparatus comprising:
a pixel data storing unit including a search target macro-block data storing unit storing pixel data of a macro-block in a current frame, and a search area macro-block data storing unit storing pixel data of macro-blocks in a search area of a frame to be searched;
a two-dimensional processing element array receiving pixel data from the pixel data storing unit and calculating a degree of similarity between the macro-block in the current frame and macro-blocks in the search area;
a merging and comparing unit merging the degree of similarity, generating degrees of similarity values corresponding to various block sizes, comparing the generated degrees of similarity, and outputting motion vectors for the blocks of various sizes; and
an address controlling unit determining an address to read in order to retrieve pixel data needed to calculate the degree of similarity from the pixel data storing unit and outputting the address is input to the two-dimensional processing element array.

18. The apparatus of claim 17, wherein the search target macro-block data storing unit is an SDRAM.

19. The apparatus of claim 17, wherein the two-dimensional PE array includes 64 processing elements in an 8×8 array.

20. The apparatus of claim 17, wherein the degree of similarity is calculated using a sum of absolute differences (SAD).

21. The apparatus of claim 17, wherein the merging and comparing unit merges calculated SAD values and generates SAD values corresponding to various block sizes used in an H.264 standard.

22. The apparatus of claim 17, wherein the search target macro-block data storing unit and the search area macro-block data storing unit are SRAMs.

23. The apparatus of claim 17, wherein the search target macro-block data storing unit 210 sequentially transmits eight 8-bit data values to an 8×8 register array connected to the two-dimensional PE array in synchronization with a system clock.

24. The apparatus of claim 23, wherein the 8×8 register array is connected to the two-dimensional PE array in units of rows and sequentially transmits pixel data of a search target macro-block to the two-dimensional PE array.

25. The apparatus of claim 24, wherein, during every clock cycle, the 8×8 register array transmits pixel data stored in each row of the register array to registers in respective next rows of the register array.

26. The apparatus of claim 17, wherein the search area macro-block data storing unit is a dual port SRAM.

27. A method of reducing wasted clock cycles in hierarchal motion estimation, comprising:
storing in a storage section pixel data of a block to be searched for and pixel data of blocks in a search area;
receiving pixel data from the pixel data storing unit and calculating, via a two-dimensional processor, degrees of similarity between the block to be searched for and the blocks in the search area;
merging the degrees of similarity, generating degrees of similarity for blocks of various sizes, comparing the generated degrees of similarity, and outputting motion vectors for the blocks of various sizes; and
sequentially transmitting the pixel data to the two-dimensional processing element array by controlling a address of the storage section.
